(19) United States
(12) Patent Application Publication
(10) Pub. No.: US 2015/0326073 A1
(43) Pub. Date: Nov. 12, 2015

(54) SYSTEMS AND METHODS FOR WIRELESSLY CHARGING ELECTRONIC DEVICES

(71) Applicant: Cable Television Laboratories, Inc., Louisville, CO (US)

(72) Inventors: Bernard McKibben, Broomfield, CO (US); Neeharika Allanki, Boulder, CO (US)

(21) Appl. No.: 14/710,200

(22) Filed: May 12, 2015

Related U.S. Application Data
(60) Provisional application No. 61/992,033, filed on May 12, 2014.

(51) Int. Cl. H02J 17/00; H04M 15/00; H02J 7/02

(52) U.S. Cl. CPC H02J 17/00; H02J 7/025; H04M 15/8038

(57) ABSTRACT

Systems and methods presented herein provide for powering of electronics. One powering system disclosed herein includes a database comprising subscription information for a plurality of network users and an electromagnetic energy source. The powering system also includes a communication hub colocated with the electromagnetic energy source and operable to establish a communication link with an electronic device of a first of the network users. The powering system also includes a network element communicatively coupled to the communication hub through a communication network to receive subscription information from the electronic device via the communication hub. The network element is further operable to access the database to verify the subscription information of the first user, and to direct the electromagnetic energy source to radiate towards the electronic device to power to the electronic device upon verification of the subscription information of the first user.

### CROSS REFERENCE TO RELATED APPLICATIONS

This patent application claims priority to, and thus the benefit of an earlier filing date from, U.S. Provisional Patent Application No. 61/992,033 (filed May 12, 2014), the contents of which are hereby incorporated by reference.

### BACKGROUND

Mobile electronics have provided mankind with many capabilities including the ability to quickly communicate with one another. As with all electronic devices, mobile electronic devices require power and that is often provided by a battery configured with the device. Battery life has improved considerably over the years but, as with all batteries, they still require charging.

One can quickly see the need for charging stations for mobile electronic devices. In fact, charging stations for a variety of mobile electronic devices can be readily found in airports where people frequently use their mobile electronic devices for business, entertainment, and the like. At these charging stations, a user typically swipes a credit card and connects the device with a power cord suited to couple to that particular device. Then, the charging station charges the device. However, these charging stations are fixed and do not provide a flexible means for charging mobile devices.

### SUMMARY

Systems and methods presented herein provide for powering of electronics, such as mobile devices including cell phones, tablet computers, laptop computers, and the like. One powering system disclosed herein includes a database comprising subscription information for a plurality of network users and an electromagnetic (EM) energy source. The powering system also includes a communication hub colocated with the EM energy source and operable to establish a communication link with an electronic device of a first of the network users. The powering system also includes a network element communicatively coupled to the communication hub through a communication network to receive subscription information from the electronic device via the communication hub. The network element is further operable to access the database to verify the subscription information of the first user, and to direct the EM energy source to radiate towards the electronic device to power to the electronic device upon verification of the subscription information of the first user.

The various embodiments disclosed herein may be implemented in a variety of ways as a matter of design choice. For example, some embodiments herein are implemented in hardware whereas other embodiments may include processes that are operable to implement and/or operate the hardware. Other exemplary embodiments, including software and firmware, are described below.

### BRIEF DESCRIPTION OF THE FIGURES

Some embodiments of the present invention are now described, by way of example only, and with reference to the accompanying drawings. The same reference number represents the same element or the same type of element on all drawings.

FIG. 1 is a block diagram of an exemplary system for wirelessly charging electronic devices.

FIG. 2 is a flowchart of an exemplary process for wirelessly charging electronic devices.

FIGS. 3 and 4 are exemplary messaging diagrams operable within a system for wirelessly charging electronic devices.

FIG. 5 is a block diagram of a Radio Frequency (RF) source being used too wirelessly charging electronic devices.

FIG. 6 is a flowchart of a process for balancing wirelessly charging needs.

FIG. 7 is a block diagram of an exemplary computing system in which a computer readable medium provides instructions for performing methods herein.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention and are to be construed as being without limitation to such specifically recited examples and conditions. As a result, the invention is not limited to the specific embodiments or examples described below.

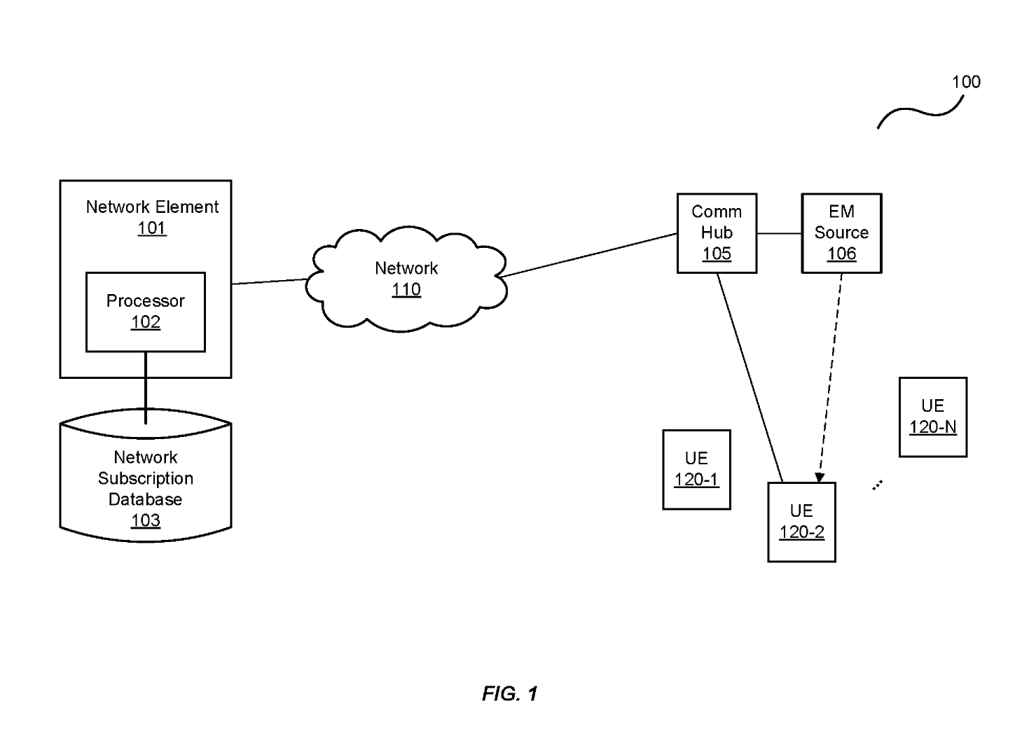

FIG. 1 is a block diagram of an exemplary system 100 for wirelessly charging electronic devices (also known as user equipment, or “UEs”). The system 100 comprises a network element 101, a network subscription database 103, a communication hub 105, and an EM radiation source 106. Generally, the UEs 120-1-120-N try to gain access to a network 110 through the communication hub 105 (where the reference “N” is merely intended to represent an integer greater than “1” and not necessarily equal to any other “N” reference designated herein). For example, the communication hub 105 may be a WiFi hotspot where the UEs, such as smart phones and tablet computers, try to gain access to the Internet. The network element 101 may verify their subscriptions to determine whether they are allowed wireless access to the network 110 via the communication hub 105. If the UEs 120 are indeed subscribers, then the network element 101 may provide the UEs 120 with access to the network 110.

In addition to providing wireless access to the network 110 through the communication hub 105, the network element 101 may direct the EM source 106 to power the subscriber UEs 120. For example, the UE 120-2 may have a battery that supplies power to the electronics of the UE 120-2. The UE 120-2 may also comprise an EM converter that receives EM energy (e.g., solar, laser, light resonator coupled to a directional gain medium, RF, microwave, or the like) and converts that energy into electrical energy that is stored with the battery of the UE 120-2. The EM radiation source 106 may charge the UE 120-2 when authorized by the network element 101.

The network element 101 is any system, device software, or combination thereof operable to grant access to the communication hub 105 for use by the UEs 120. Generally, the network element 101 comprises a processor 102 that is operable to process data from the UEs 120 and transfer various forms of data to the UEs 120. In this regard, the processor 102 may receive the subscription information from the UEs 120 and verify that information based on information stored in the network subscription database 103.

The network subscription database 103 may be implemented in a variety ways as a matter design choice. The communication hub 105 may also be implemented in a variety ways as a matter design choice. For example, the communication hub 105 may be implemented as a WiFi hotspot, a wireless access point (WAP), a cell tower, or the like. Accordingly, communications between the communication hub 105 and the UEs 120 may comprise any of a variety of protocols including Long Term Evolution (LTE), WiFi, Internet protocol, Bluetooth, or the like.

The EM radiation source 106 may also be implemented in a variety ways as a matter of design choice. In some embodiments, the EM radiation source 106 comprises a directional laser that may be used to direct laser energy to a specific UE 120 at an identified location. One example method of directional light charging links light resonance via retro-reflective mirrors to a directional gain medium. The directional gain medium enables and disables the light resonance for charging in a specific direction as towards the mobile device. Alternatively or additionally, the EM radiation source 106 may be a directional RF antenna that directs RF energy to a specific UE 120 at an identified location. Such embodiments are shown and described in greater detail below.

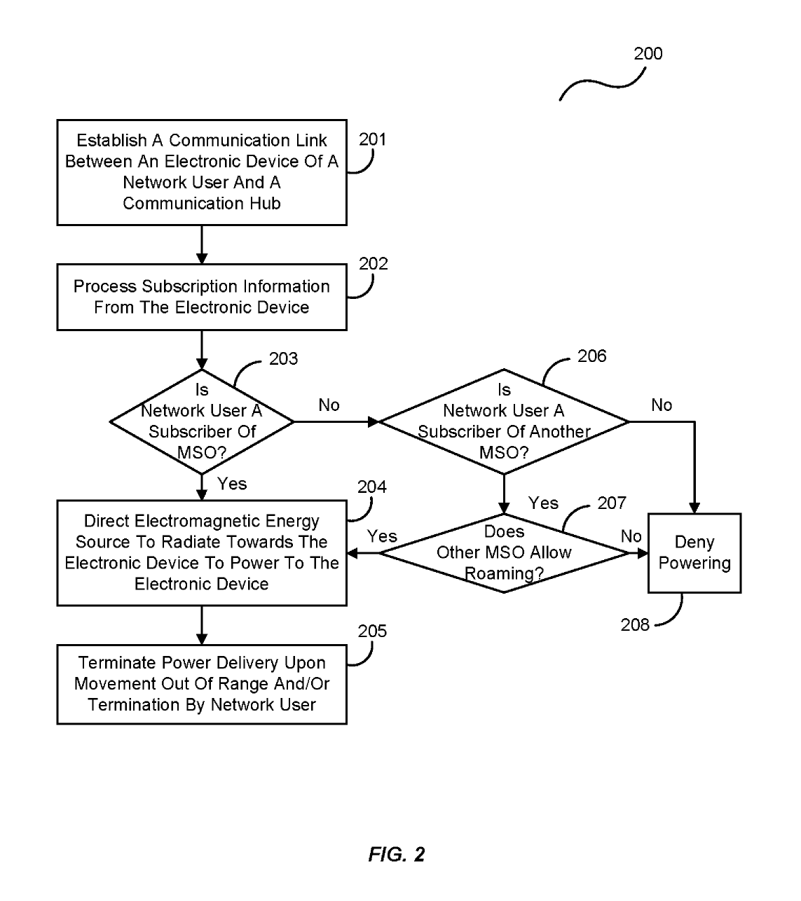

One exemplary process 200 of the system 100 of FIG. 1 is now shown and described with respect to the flowchart of FIG. 2. In this embodiment, the communication hub 105 establishes a communication link between the electronic device (e.g., the UE 120-2) of a network user, in the process element 201. In the process element 202, the network element 101 processes subscription information from the electronic device to determine whether the network user is a subscriber to the multisystem operator (MSO) operating the network element 101 (i.e., the process element 203). Note that, while MSOs are identified here, mobile operators and other fixed network operators can use this invention in the same way as well. For example, the network element 101 and received credentials indicating that the user of the electronic device is a subscriber to the MSO. The processor 102 of the network element 101 may then compare those credentials to information stored in the network script database 103.

If the user is a subscriber of the MSO, then the network element 101 may grant access to the electronic device to conduct communications through the network 110. The network element 101 also directs the EM radiation source 106 to radiate towards the electronic device and power the electronic device, in the process element 204. For example, once the network element 101 verifies that the UE 120-2 is a subscriber of the MSO, then the network element may direct a directional laser source to being laser energy towards the UE 120-2. Similarly, the network element may direct enable a directional gain medium to provide light resonance towards the UE. Assuming that the UE 120-2 comprises an opto-electrical converter, then the opto-electrical converter converts the laser energy to electrical energy that may be used by the onboard electronics of the UE 120-2 and/or to charge the battery of the UE 120-2.

The network element 101 may monitor the electronic device to determine whether the network element 100 and one should terminate our delivery to the device, in the process element 205. For example, if the UE 120-2 is out of a range of the communication hub 105, then the network element 101 may determine that power delivered by the EM radiation source 106 is no longer feasible as the EM source 106 is colocated with the communication hub 105 and out of range as well. Alternatively or additionally, the user may turn off the UE 120-2 and/or may no longer require power. In any case, the network element 101 may direct the EM radiation source 106 to terminate energy delivered to the UE 120-2.

If, on the other hand, the user of the electronic device is not a subscriber of the MSO, the network element 110 may determine whether the user is a subscriber of another MSO, in the process element 206. For example, some users of electronic devices have subscriptions which allow “roaming” among various other communication networks. While these roaming features may incur additional charges, a user may still be granted access to the network 110. In this regard, the network element 101 may determine whether the user has a roaming subscription feature enabled with the other MSO, in the process element 207. If so, the network element 101 may direct the EM radiation source 106 to transfer EM radiation to the electronic device, in the process element 204. Otherwise, the network element 101 may deny powering to the electronic device, in the process element 208.

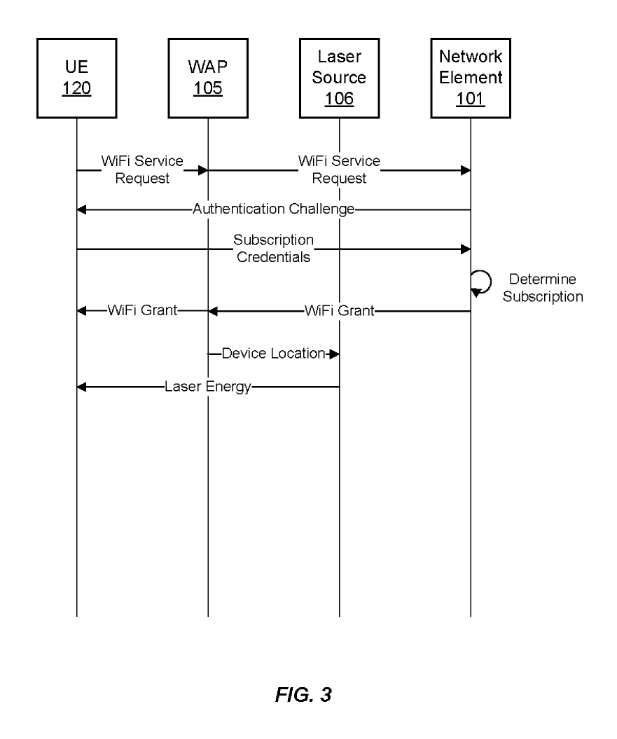

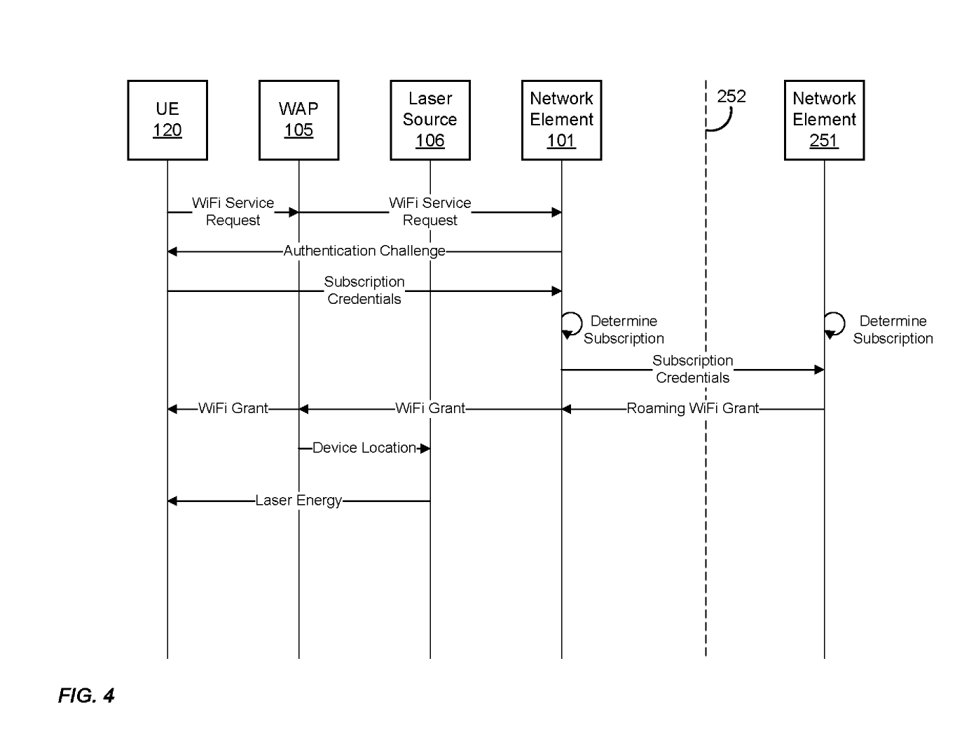

FIGS. 3 and 4 illustrate two exemplary messaging diagrams of the powering system of FIG. 1. In these two exemplary embodiments, the EM radiation source 106 is a directional laser and the communication hub 105 is a WiFi hotspot (e.g., a WAP). In FIG. 3, the process generally initiates when the UE 120 requests WiFi service through the WAP 105. The WAP 105 transfers the request to the network element 101 which, in turn, provides an authentication challenge to the UE 120 through the WAP 105. The UE 120 transfers subscription credentials to the network element 101 (e.g., through the WAP 105 or through another data network to which the user subscribes, such as a 4G network, an LTE network, or the like).

The network element 101 then determines a subscription status of the user of the UE 120. Assuming that the user is a subscriber of the MSO operating the network element 101, the network element 101 grants WiFi access to the UE 120 through the WAP 105. In doing so, the WAP 105 communicates location information of the UE 120 to the directional laser source 106. For example, the WAP 105 may be operable to estimate a location of the UE 120 based on a signal strength of the WiFi channel between the UE 120 and the WAP 105. With this information, the WAP 105 may transfer the location information of the UE 120 to the laser source 106 such that the laser source 106 can directionally transmit laser energy to the UE 120. As mentioned above, assuming that the UE 120 comprises an opto-electrical converter, the UE 120 converts the laser energy into electrical energy usable by the electronic components of the UE 120 including the battery of the UE 120.

FIG. 4 illustrates an embodiment is similar to FIG. 3 but also illustrates another network element 251 being present. In this embodiment, the network element 101 belongs to a first MSO whereas the network element 251 belongs to a second different MSO. The network element 251 is part of a “home network” to which the UE 120 subscribes. The network element 101 is part of a “visiting network” where the UE 120 “roams”, as illustrated by the dashed line 252.

The UE 120 roaming within the visiting network of a network element 101 requests WiFi service from the WAP 105. However, upon determining that the UE 120 is not a subscriber of the visiting network, the network element 101 transfers the subscription credentials of the UE 120 to the network element 251 for verification. Once the network element 251 in the home network verifies credentials of the UE 120, the network element 251 may grant access for WiFi roaming to the UE 120 within the visiting network. Such may include the network element 251 directing the network element 101 to present roaming features, options, and/or billing information.

In any case, assuming that the UE 120 is allowed to run with the visiting network, the network element 101 may transfer a WiFi grant such that the UE 120 can gain WiFi access through the WAP 105. Again, the WAP 105 then transfers the device location information to the laser source 106 such that the laser source can direct laser energy to the UE 120 for charging.

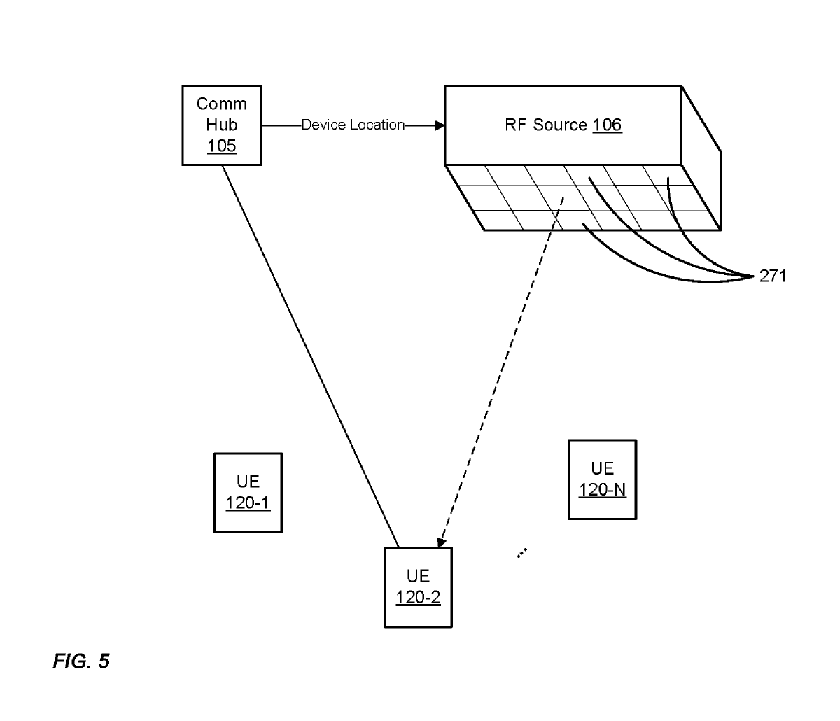

FIG. 5 is a block diagram of an exemplary directional RF antenna as the EM radiation source 106 that may be used in place of the laser previously described. The RF antenna may comprise a plurality of antenna elements 271 that directionally radiate RF energy to a UE 120. Thus, when the UE 120-2 establishes communications with the communication hub 105 and the communication hub 105 ascertains the location of the UE 120-2, then the RF antenna selects an antenna element or elements 271 that are best suited for delivering RF energy to the UE 120-2. For example, the RF energy delivered from the source 106 may be microwave and therefore highly directional. The antenna elements 271 may be pre-configured in a certain orientation so as to beam highly directional microwave energy to any particular UE 120. Thus, when the RF antenna 106 receives the location information of the UE 120-2, the RF antenna 106 may determine the antenna element 271 best suited for delivering the microwave energy to the UE 120-2.

The invention is not intended be limited to any particular form of EM energy. Nor is the invention intended be limited to any particular directional control over the EM energy. For example, while the embodiment in FIG. 5 illustrates an RF antenna with a plurality of preconfigured directional antenna elements 271, another RF antenna may control the directionality of individual antenna elements 271 so as to assign an individual antenna element 271 without regard to location of the UE 120. In other words, once an antenna element 271 is assigned to a UE 120, the RF antenna 106 may change the direction in which the assigned antenna element 271 beams the RF energy so as to account for movement by the UE 120-2.

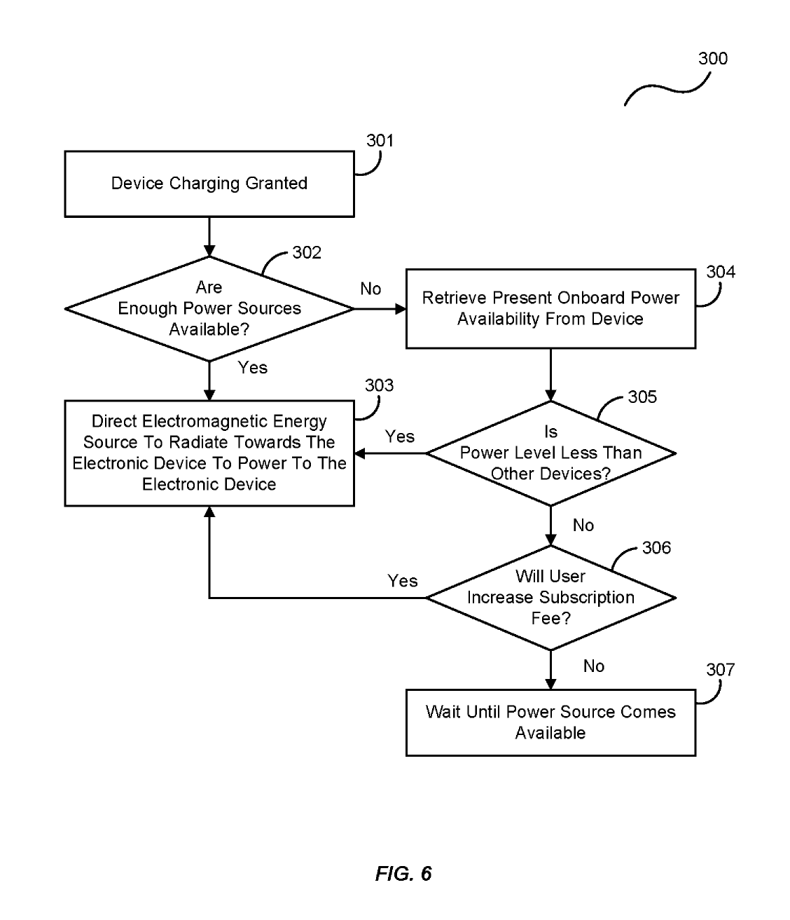

FIG. 6 illustrates a flowchart of another exemplary process 300 of the system 100 of FIG. 1. In this embodiment, the process 300 is operable to provide load balancing of power delivery to a plurality of electronic devices (e.g., the UEs 120). For example, if the number of UEs 120 requesting power delivery from any of the various embodiments disclosed herein is greater than the number of power delivery abilities of the system 100 (e.g., number of lasers, number of antenna elements, etc.), then the network element 101 may determine which UEs 120 are to receive power charging access.

With this in mind, the process initiates after a UE 120 has been granted access for device charging, in the process element 301. The network element 101 or some other device (e.g., a smart antenna) determines whether enough power delivery sources are available, in the process element 302. If enough power delivery sources are available, then the network element 101 direct the EM energy source 106 to radiate towards the electronic device as before, in the process element 303.

If, however, there are not enough available power sources to transfer EM energy to the UE 120, the network element 101 may retrieve the present onboard power availability of the device, in the process element 304. For example, the network element 101 may request the UE 120-2 to show how much power remains in the battery of the UE 120-2. From there, the network element 101 may determine whether that power level is less than other devices being powered by the EM radiation source 106, in the process element 305. If the UE 120-2 has less power than the other devices (e.g., the UEs 120-1 and 120-3-120-N), then the network element 101 may direct the EM radiation source 106 to drop another device from power delivery. Then, the network element 101 may direct the EM radiation source 106 to radiate the energy to the UE 120-2, in the process element 303.

If the power level of the UE 120-2 is not less than the other devices, the network element 101 may request a subscription fee increase to the wireless energy delivery desired by the UE 120-2, in the process element 306. For example, the network element 101 may transfer an SMS link or a webpage to the UE 120-2 to determine whether the user of the UE 120-2 would like to pay extra for EM energy delivery. If so, the network element 101 may charge/bill the user of the UE 120-2 for the service and then direct the EM radiation source 106 to radiate to the UE 120-2. If the user of the UE 120-2 does not want to increase its subscription fee for the EM energy delivery, the network 101 may simply wait until another power source comes available, in the process element 307, to assign the source to the UE 120-2.

Alternatively or additionally, the network element 101 may perform some other form of load balancing of energy delivery to the UEs 120 including, for example, round robin techniques to assign various lasers/antenna elements 271 to the individual UEs 120 within range of the communication hub 105.

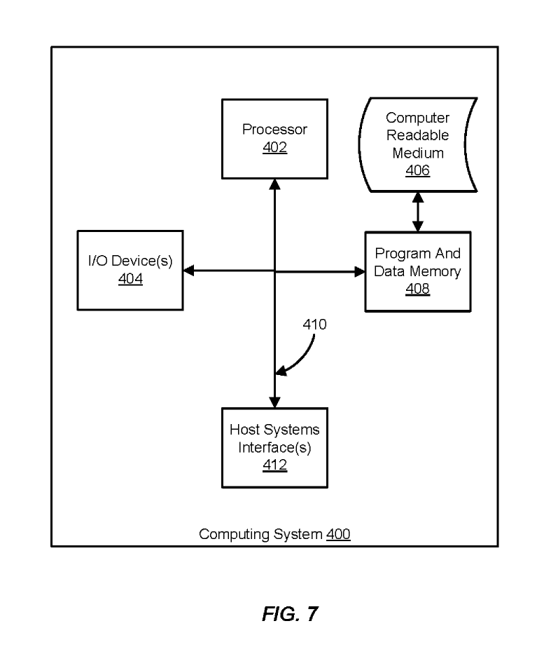

Additionally, the invention can take the form of an entirely hardware embodiment, an entirely software embodiment or an embodiment containing both hardware and software elements. In one embodiment, the invention is implemented in software, which includes but is not limited to firmware, resident software, microcode, etc. FIG. 7 illustrates a computing system 400 in which a computer readable medium 406 may provide instructions for performing any of the methods disclosed herein.

Furthermore, the invention can take the form of a computer program product accessible from the computer readable medium 406 providing program code for use by or in connection with a computer or any instruction execution system. For the purposes of this description, the computer readable medium 406 can be any apparatus that can tangibly store the program for use by or in connection with the instruction execution system, apparatus, or device, including the computer system 400.

The medium 406 can be any tangible electronic, magnetic, optical, EM, infrared, or semiconductor system (or apparatus or device). Examples of a computer readable medium 406 include a semiconductor or solid state memory, magnetic tape, a removable computer diskette, a random access memory (RAM), a read-only memory (ROM), a rigid magnetic disk and an optical disk. Some examples of optical disks include compact disk-read only memory (CD-ROM), compact disk-read/write (CD-R/W) and DVD.

The computing system 400, suitable for storing and/or executing program code, can include one or more processors 402 coupled directly or indirectly to memory 408 through a system bus 410. The memory 408 can include local memory employed during actual execution of the program code, bulk storage, and cache memories which provide temporary storage of at least some program code in order to reduce the number of times code is retrieved from bulk storage during execution. Input/output or I/O devices 404 (including but not limited to keyboards, displays, pointing devices, etc.) can be coupled to the system either directly or through intervening I/O controllers. Network adapters may also be coupled to the system to enable the computing system 400 to become coupled to other data processing systems, such as through host systems interfaces 412, or remote printers or storage devices through intervening private or public networks. Modems, cable modem and Ethernet cards are just a few of the currently available types of network adapters.

What is claimed is:

1. A powering system for electronic devices, the system comprising:
a database comprising subscription information for a plurality of network users;
an electromagnetic energy source;
a communication hub colocated with the electromagnetic energy source and operable to establish a communication link with an electronic device of a first of the network users; and
a network element communicatively coupled to the communication hub through a communication network to receive subscription information from the electronic device via the communication hub, wherein the network element is further operable to access the database to verify the subscription information of the first user, and to direct the electromagnetic energy source to radiate towards the electronic device to power to the electronic device upon verification of the subscription information of the first user.

2. The powering system of claim 1, wherein:
the electromagnetic energy source is a laser.

3. The powering system of claim 1, wherein:
the electromagnetic energy source is a directional medium coupled to retro-reflective mirrors to form directional light resonance.

4. The powering system of claim 1, wherein:
the electromagnetic energy source comprises a directional radio frequency antenna.

5. The powering system of claim 1, wherein:
the communication hub is a WiFi Access Point.

6. The powering system of claim 1, wherein:
the communication hub is a cell tower.

7. The powering system of claim 1, wherein:
the network element is operable to determine that the communication hub is owned by a Multi System Operator (MSO) that is different from an MSO of the network element, to determine that the electronic device is roaming, and to allow monetary charging to the first user for roaming service of the electronic device.

8. A method for powering electronic devices, the method comprising:
establishing a communication link between an electronic device of a network user and a communication hub;
receiving, at a network element, subscription information from the electronic device through a communication network via the communication hub;
accessing a database to verify the subscription information of the network user; and
directing an electromagnetic energy source to radiate towards the electronic device to power to the electronic device upon verification of the subscription information of the first user.

9. The method of claim 8, wherein:
the electromagnetic energy source is a laser.

10. The method of claim 8, wherein:
the electromagnetic energy source is a directional medium coupled to retro-reflective mirrors to form directional light resonance.

11. The method of claim 8, wherein:
the electromagnetic energy source comprises a directional Radio Frequency (RF) antenna.

12. The method of claim 8, wherein:
the communication hub is a WiFi Access Point.

13. The method of claim 8, wherein:
the communication hub is a cell tower.

14. The method of claim 8, further comprising:
determining that the communication hub is owned by a Multi System Operator (MSO) that is different from an MSO of the network element;
determining that the electronic device is roaming; and
allowing monetary charging to the first user for roaming service of the electronic device.
